(19) United States
(12) Patent Application Publication
(10) Pub. No.: US 2025/0028965 A1
(43) Pub. Date: Jan. 23, 2025

(54) WEIGHT QUANTIZATION ADAPTATION TECHNOLOGY

(71) Applicant: Intel Corporation, Santa Clara, CA (US)

(72) Inventors: Alexander Kozlov, Dubai (AE); Andrey Anufriev, Taufkirchen (DE); Nikolay Lyalyushkin, Munich (DE); Dmitry Gorokhov, Dubai (AE); Yury Gorbachev, Novgorod (RU)

(21) Appl. No.: 18/904,364

(22) Filed: Oct. 2, 2024

(51) Int. Cl. G06N 3/082

(52) U.S. Cl. CPC G06N 3/082

(57) ABSTRACT

Systems, apparatuses and methods may provide for technology that selects a subset of linear layers from a plurality of linear layers in a pre-trained artificial intelligence (AI) model, wherein a quantization error of the subset of linear layers exceeds an error threshold. For each linear layer in the subset of linear layers, the technology solves a singular value decomposition (SVD) approximation, generates a first adapter layer and a second adapter layer based on the SVD decomposition, wherein the first adapter layer and the second adapter layer include weight matrices having a first dimension that is less than a first rank threshold and a second dimension that is greater than a second rank threshold, and determines an inference output based on the linear layer, the first adapter layer and the second adapter layer.

### BACKGROUND

Large Language Models (LLMs) represent recent breakthroughs in generative artificial intelligence (AI) use cases. Execution of LLMs on edge/client devices, however, is limited due to memory pressure during the loading of weights throughout the inference process. Regardless of computational operations (“compute”), the majority of limitations are due to high memory bandwidth requirements. Additionally, the distribution of LLMs for edge/clients is an issue due to model sizes that can reach tens of Gigabytes.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a linear layer adaptation process according to an embodiment;

FIG. 2 is an illustration of a chart of normalized quantization error versus iteration according to an embodiment;

FIG. 3A is a block diagram of an adapted linear layer with quantization according to an embodiment;

FIG. 3B is a block diagram of an adapted linear layer without quantization according to an embodiment;

FIG. 4 is an illustration of an example of a pseudo code listing to adapt linear layers according to an embodiment;

FIG. 5 is a flowchart of an example of a method of operating a performance-enhanced computing system according to an embodiment;

FIG. 6 is a flowchart of an example of a method of solving a singular value decomposition (SVD) approximation according to an embodiment;

FIG. 7 is a flowchart of an example of a method of determining an inference output according to an embodiment;

FIG. 8 is a block diagram of an example of a performance-enhanced computing system according to an embodiment;

FIG. 9 is an illustration of an example of a semiconductor package apparatus according to an embodiment;

FIG. 10 is a block diagram of an example of a processor according to an embodiment; and

FIG. 11 is a block diagram of an example of a multi-processor based computing system according to an embodiment.

### DETAILED DESCRIPTION

Recent approaches to solving the technical problems associated with deploying large language models (LLMs) is to compress model weights (e.g., mostly via quantization techniques). A typical issue with this approach is that model accuracy may degrade. To tackle the accuracy problem, pre-and post-optimization techniques have been proposed. These optimization techniques, however, either do not provide control over how much accuracy is to be restored or are not easily deployed.

More particularly, weight-only quantization is an approach to reduce the inference latency of LLMs and there are multiple approaches that attempt to improve the accuracy of these models at weight quantization. Conventional accuracy improvement solutions, however, all have some drawbacks.

For example, QLoRA (Quantized Low Rank Adapters) attempts to quantize the weights of linear layers (e.g., fully connected and/or dense layers that transform an input tensor into an output vector by performing a linear operation that involves weights and biases) to the low-bit data type selected by the user while introducing so-called low rank adapters. These adapters are essentially a combination of two additional linear layers with weight matrices of low rank (e.g., 16). These Linear layers are subsequently applied to the same input and output of the adapter and summed with the output of the optimized source layer. QLoRA attempts to speed up the fine-tuning of an LLM model to downstream tasks and reduce the amount of memory involved during the fine-tuning. This solution suggests fusing the adapters back to the model at the model deployment stage to obtain a floating-point type (e.g., 16-bit floating point/FP16).

LoftQ (Low Rank Adapter Fine-Tuning-Aware Quantization) is another approach that essentially repeats the QLoRA approach but with the goal of obtaining an optimized adapted version of the model for deployment. LoftQ also relies on fine-tuning to improve the accuracy of the model but proposes an improved initialization of the low rank adapters to speed up the fine-tuning process. The solution requires a significant dataset and the availability of training hardware (HW). Another drawback is that the inference of low rank adapters involves floating-point execution and does not work with dynamic quantization, which is another popular inference latency reduction solution.

The technology described herein proposes a model optimization technique that substantially improves the accuracy of LLM models with negligible overhead on the model size and inference latency. Thus, the technology described herein enables the application of any generic optimization such as low-bit weight quantization, without compromising accuracy significantly.

More particularly, embodiments provide a solution that is based on the low rank adaptation approach for a more accurate and efficient LLM optimization for deployment. Accordingly, the technology described herein can significantly improve the accuracy of the optimized LLM models at negligible overhead on model footprint or inference latency. The solution is lightweight, fast, and does not require the availability of training HW. Compared to other approaches, the technology described herein produces more efficient models that are fully compatible with the dynamic quantization of activations, which can lead to a further reduction in inference latency.

The technology described herein involves low rank adaptation of the model, which undergoes some optimization that changes the weights of the model. Recently, weight-only quantization (e.g., 4-bit integer/INT4 quantization) is a popular approach to conducting LLM optimization. Thus, it can be assumed that the weights of the linear layers of the model are quantized to the specified data type. This quantization typically leads to degradation of model accuracy, which sometimes can be significant. To restore the accuracy, embodiments introduce the following adaptation solution that includes two basic phases:
Phase 1: Select the most problematic linear layers with the highest quantization error.
Phase 2: Introduce an adapter for each selected linear layer to reduce quantization error.

In the first phase, the intermediate outputs of the optimized and baseline (e.g., original pre-trained) models are collected and a metric is applied to compute a score value that reflects quantization error. This metric can be Signal to Quantization Noise Ratio (SQNR), approximation of Hessian Trace, some variance-based metrics, etc. (e.g., depending on the user preference). To facilitate discussion, SQNR be used herein. After all scores of linear layers are computed, the top-k layers with the highest error are selected (e.g., subset of linear layers), where k is a user-defined parameter. In the default case, all optimized layers can be considered for adaptation.

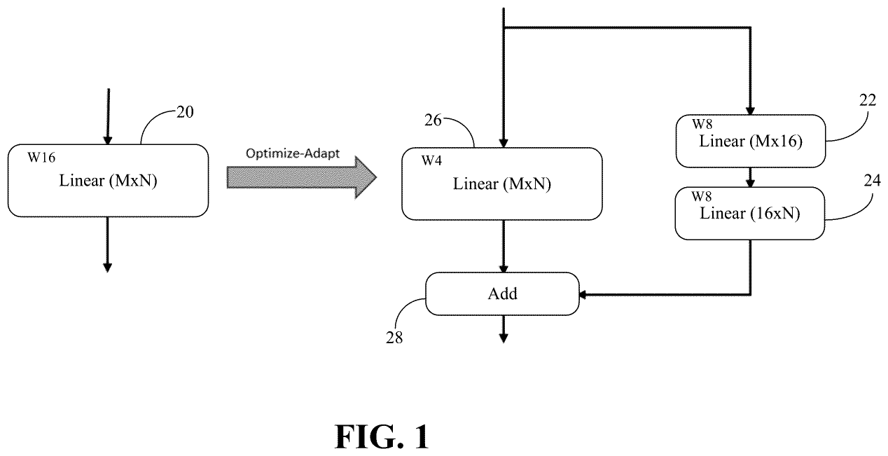

FIG. 1 demonstrates that an adaptation process is applied in the second phase to each selected linear layer 20 that is quantized into an optimized linear layer 26. This adaptation process results in two additional linear layers—a first adapter layer 22 and a second adapter layer 24—with weight matrices of low rank. These adapter layers 22, 24 are executed in parallel with the optimized linear layer 26 and the results of the two branches are summed by an adder 28. “Low rank” refers to the fact that both the adapter layers 22, 24 have weight matrices with one small dimension (e.g., 4096×16 and 16'4096).

Regarding the creation of the low rank adapter layers 22, 24, it can be assumed that W is a weight matrix with shape [M, N] of the linear layer 20 of an LLM, and W_{q} are quantized weights. X is some corresponding aggregated input activations (e.g., over some relatively small dataset) for this linear layer 20 with shape [N, T], where T is the number of averaged tokens across T texts from the calibration datasets. To minimize the quantization error with low rank adapter layers 22, 24, the following loss function L=((W_{q}−W)·Xₐ−Uₗᵣ·Vₗᵣ·Xₐ)² may be introduced for arbitrary valid input Xₐ for this linear layer 20, where Uₗᵣ and Vₗᵣ are unknown matrices with shapes [M, R] and [R, N], respectively (low rank decomposition), R<<min (M, N) (e.g., 8, 16, etc.).

A common solution for this task may be to take the first R columns and rows from the Singular Value Decomposition (SVD) of the weights residual matrix: Wᵣ=W−W_{q}, (U, S, V)=SVD(Wᵣ) and Uₗᵣ=U[:,:R]·S[:R,: R], Vₗᵣ=V [:R,:]. Since this formula does not take into account, however, the distribution of activations, which has a significant impact on the final accuracy of the quantized network, (Wᵣ−Uₗᵣ·Vₗᵣ)² is not minimized for this task. Rather, the technology described herein approximates the distribution of Xₐ with the collected statistic X. First, a vector of scaleₐ=max(X, dim=1) with shape N is computed and then the vector is normalized by a quantization dimension (group size) and compute SVD (Wᵣ·scaleₐ) (e.g., rather than SVD(Wᵣ)) as an initial approximation for Uₗᵣ, Vₗᵣ.

To rectify the first approximation of Uₗᵣ, Vₗᵣ, the same precomputed statistics X are used to iteratively minimize (Wᵣ·X−Uₗᵣ·Vₗᵣ·X)² according to the following process:
for i in range (n_iterations):
   Compute least-squares solution to equation Uₗᵣ·(Vₗᵣ·X)=Wᵣ·X with respect to Uₗᵣ at fixed Vₗᵣ
   Compute least-squares solution to equation Vₗᵣ·X=Uₗᵣ⁻¹·Wᵣ·X with respect to Vₗᵣ at fixed Uₗᵣ

This optimization process is applied in a layer-wise fashion to every rectifying linear layer 20 in the model.

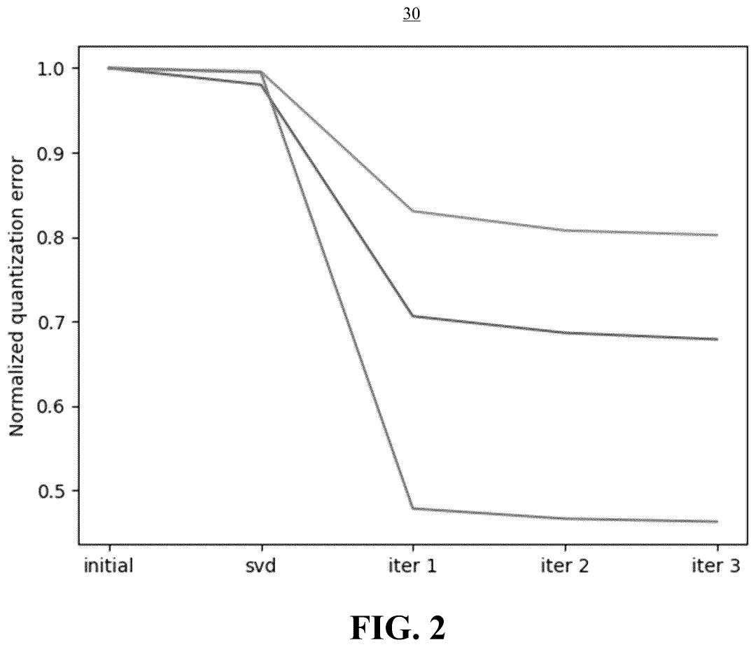

FIG. 2 shows a chart 30 of normalized quantization error for multiple layers in a model (e.g., each curve represents a different layer in the model). The chart 30 demonstrates that the approach converges to a better solution in comparison with the initial approximation.

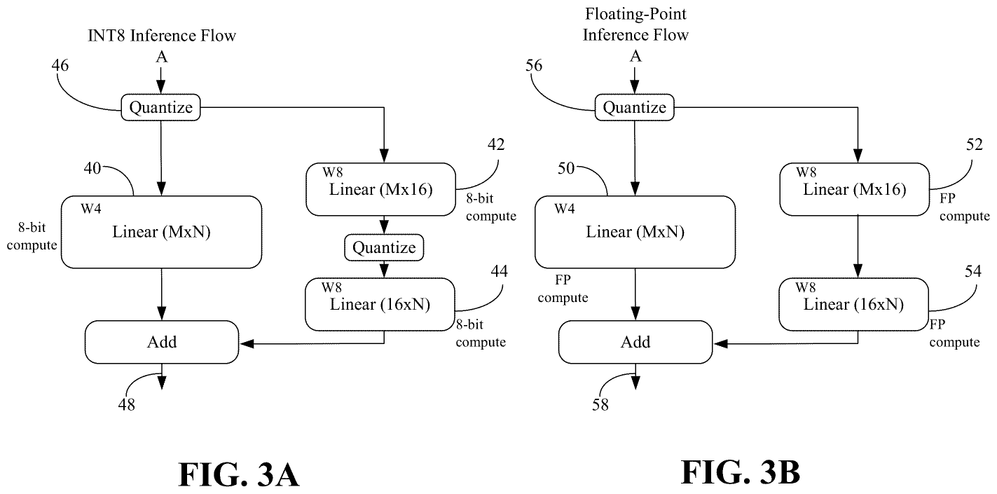

FIG. 3A shows an adapted linear layer 40 with quantization. In the illustrated example, a first compute output (e.g., 8-bit compute) of a first adapter layer 42 is determined based on an activation input 46, a second compute output (e.g., 8-bit compute) of a second adapter layer 44 is determined based on the first compute output, and a third compute output (e.g., 8-bit compute) of the linear layer 40 is determined based on the activation input 46, wherein the activation input and the first compute output are quantized. Additionally, the second compute output is summed with the third compute output to obtain an inference output 48.

Thus, to make the low rank adapter layers 42, 44 even more lightweight and friendly to inference setups, the adapter layers 42, 44 are quantized symmetrically to 8-bit integer (INT8) precision. The quantization can be performed at the rectification process already discussed, which leads to a better approximation. The INT8 low rank adapter layers 42, 44 enable a more efficient inference when activations of the model are also quantized (e.g., with INT8 dynamic quantization).

FIG. 3B shows an adapted linear layer 50. In the illustrated example, a first compute output (e.g., FP compute) of a first adapter layer 52 is determined based on an activation input 56, a second compute output (e.g., FP compute) of a second adapter layer 54 is determined based on the first compute output, and a third compute output (e.g., FP compute) of the linear layer 50 is determined based on the activation input 56, wherein the activation input and the first compute output are not quantized. Additionally, the second compute output is summed with the third compute output to obtain an inference output 58. Thus, in the case of floating-point activations, low-precision adapters can be upconverted to the floating-point precision during model loading.

The technology described herein is flexible in terms of the number of layers that are adapted and usually low rank adapters are introduced only for the few most impactful layers. Such an approach enables more lightweight and optimal models to be obtained after adaptation.

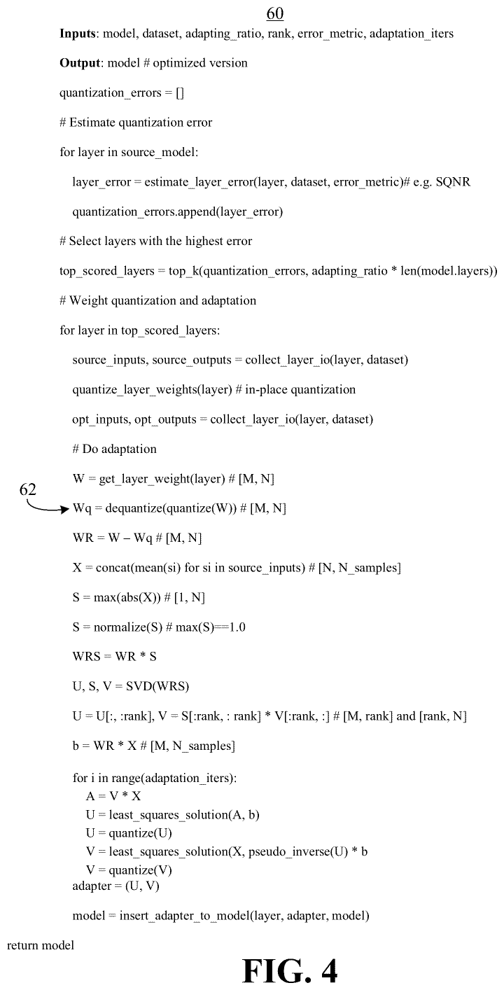

FIG. 4 shows a pseudo code listing 60 to adapt linear layers. The listing 60 provides for weight quantization and adaptation. In an embodiment, outputs of the optimized and baseline models are collected only once. This approach is less prone to overfitting the dataset and enables a relatively small dataset to be used for activation collection. The approach also speeds up the entire optimization process. In practice, the optimal implementation of the optimization and adaptation process can be performed gradually. First, the layers with the highest quantization score are estimated in line 62 without actual quantization of the weights using a so-called “fake” quantization approach. Then, linear layers are optimized and adapted in a topological order and only inputs and outputs of the current optimized and baseline layers are stored in memory. Such an approach enables model optimization to be conducted with memory and compute-limited HW.

The illustrated approach improves accuracy relative to 32-bit floating point (FP32), 4-bit normal floating point (NF4), NF4 combined with LoftQ, and 4-bit integer (INT4) solutions for different pre-trained AI models.

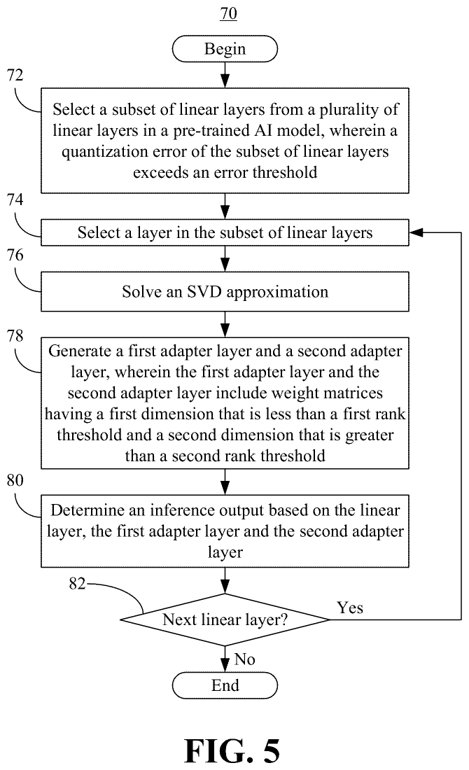

FIG. 5 shows a method 70 of operating a performance-enhanced computing system. The method 70 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 70 can be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 72 provides for selecting a subset of linear layers from a plurality of linear layers in a pre-trained AI model, wherein a quantization error of the subset of linear layers exceeds an error threshold. In one example, the subset of linear layers is selected based on one or more signal to quantization noise ratio (SQNR) values. Block 74 selects a layer in the subset of linear layers and block 76 solves an SVD approximation. The specifics of the SVD approximation are discussed in greater detail below. Additionally, block 78 generates a first adapter layer and second adapter layer, wherein the first adapter layer and the second adapter layer include weight matrices having a first dimension that is less than a first rank threshold and a second dimension that is greater than a second rank threshold (e.g., first adapter layer weight matrices are 4096×16 and second adapter layer weight matrices are 16×4096). Block 80 determines an inference output based on the linear layer, the first adapter layer and the second adapter layer. A determination is made at block 82 as to whether there are remaining linear layers in the subset of linear layers. If so, the method 70 returns to block 74. Otherwise, the method 70 terminates.

The method 70 therefore enhances performance at least to the extent that focusing the adaptation on the most problematic linear layers improves accuracy while minimizing the overhead impact on model footprint and inference latency. Additionally, the method 70 is lightweight, fast, and does not require the availability of training HW. Compared to other approaches, the method 70 produces more efficient models that are fully compatible with the dynamic quantization of activations, which can lead to further reduction in inference latency.

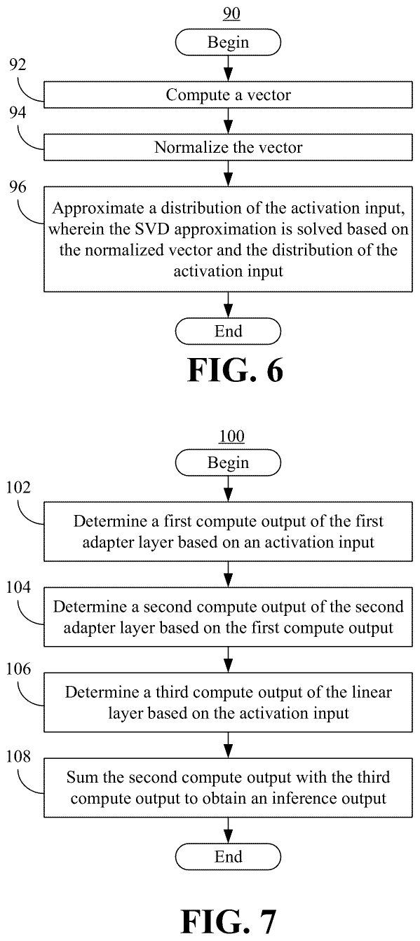

FIG. 6 shows a method 90 of solving an SVD approximation. The method 90 may generally be incorporated into block 76 (FIG. 5), already discussed. More particularly, the method 90 may be implemented in one or more modules as a set of logic instructions stored in a machine-or computer-readable storage medium such as RAM, ROM, PROM, firmware, flash memory, etc., in hardware, or any combination thereof. Illustrated processing block 92 provides for computing a vector and block 94 normalizes the vector. Block 96 approximates a distribution of the activation input, wherein the SVD approximation is solved based on the normalized vector and the distribution of the activation input.

FIG. 7 shows a method 100 of determining an inference output. The method 100 may generally be incorporated into block 80 (FIG. 5), already discussed. More particularly, the method 100 may be implemented in one or more modules as a set of logic instructions stored in a machine-or computer-readable storage medium such as RAM, ROM, PROM, firmware, flash memory, etc., in hardware, or any combination thereof. Illustrated processing block 102 provides for determining a first compute output of the first adapter layer based on an activation input. Block 104 determines a second compute output of the second adapter layer based on the first compute output. Additionally, block 106 determines a third compute output of the linear layer based on the activation input, wherein block 108 sums the second compute output with the third compute output to obtain an inference output. In one example, the method 100 quantizes the activation input and the first compute output to a data format such as, for example, the INT8 data format.

In an embodiment, the method 70 (FIG. 5), the method 90 (FIG. 6) and/or the method 100 (FIG. 7) are incorporated into an INTEL OPENVINO tookit, which streamlines AI model development and integration of deep learning in domains such as computer vision, large language models, and generative AI. In such a case, the use of weight quantization adaptation as described herein improves accuracy, reduces model size and/or reduces latency during inference operations.

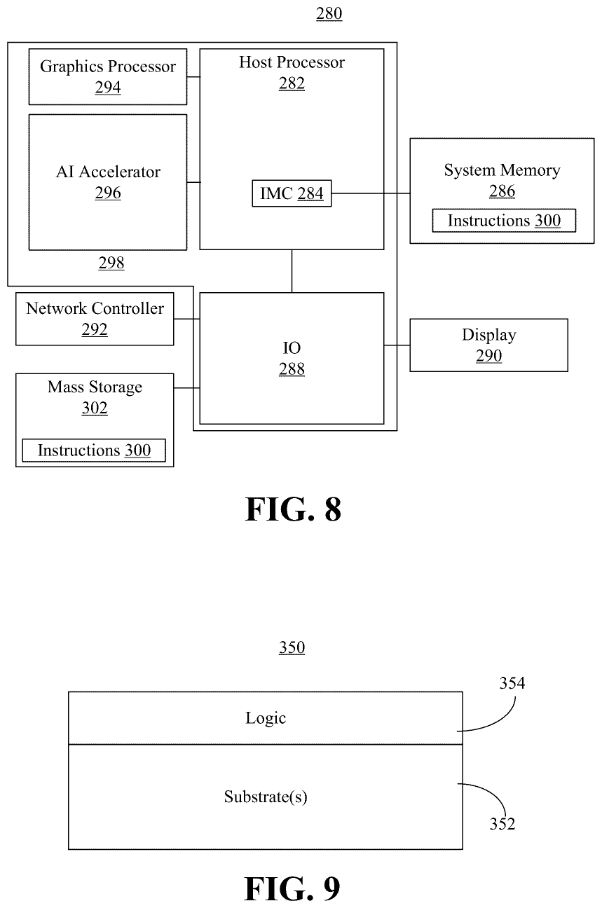

Turning now to FIG. 8, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including dynamic RAM/DRAM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 and/or the host processor 282 execute instructions 300 retrieved from the system memory 286 and/or the mass storage 302 to perform one or more aspects of the method 70 (FIG. 5), the method 90 (FIG. 6) and/or the method 100 (FIG. 7), already discussed. Thus, execution of the instructions 300 causes the AI accelerator 296, the host processor 282 and/or the computing system 280 to select a subset of linear layers from a plurality of linear layers in a pre-trained AI model (e.g., source model), wherein a quantization error of the subset of linear layers exceeds an error threshold. For each linear layer in the subset of linear layers, execution of the instructions 300 causes the AI accelerator 296, the host processor 282 and/or the computing system 280 to solve an SVD approximation, generate a first adapter layer and a second adapter layer based on the SVD approximation, wherein the first adapter layer and the second adapter layer include weight matrices having a first dimension that is less than a first rank threshold and a second dimension that is greater than a second rank threshold, and determine an inference output based on the linear layer, the first adapter layer and the second adapter layer.

The computing system 280 is therefore considered performance-enhanced at least to the extent that focusing the adaptation on the most problematic linear layers improves accuracy while minimizing the overhead impact on model footprint and inference latency. Additionally, the computing system 280 is lightweight, fast, and does not require the availability of training HW. Compared to other approaches, the computing system 280 produces more efficient models that are fully compatible with the dynamic quantization of activations, which can lead to further reduction in inference latency.

FIG. 9 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 70 (FIG. 5), the method 90 (FIG. 6) and/or the method 100 (FIG. 7), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

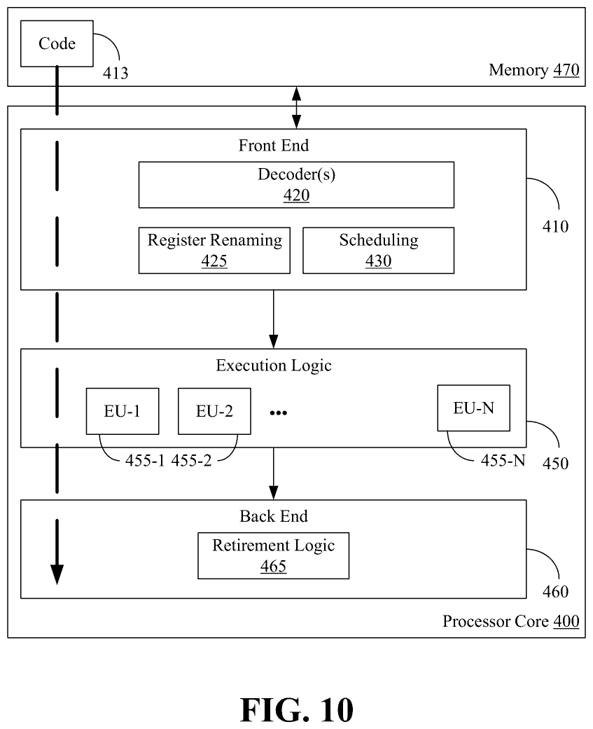

FIG. 10 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 10, a processing element may alternatively include more than one of the processor core 400 illustrated in FIG. 10. The processor core 400 may be a single-threaded core or, for at least one embodiment, the processor core 400 may be multithreaded in that it may include more than one hardware thread context (or “logical processor”) per core.

FIG. 10 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 5), the method 90 (FIG. 6) and/or the method 100 (FIG. 7), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 10, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

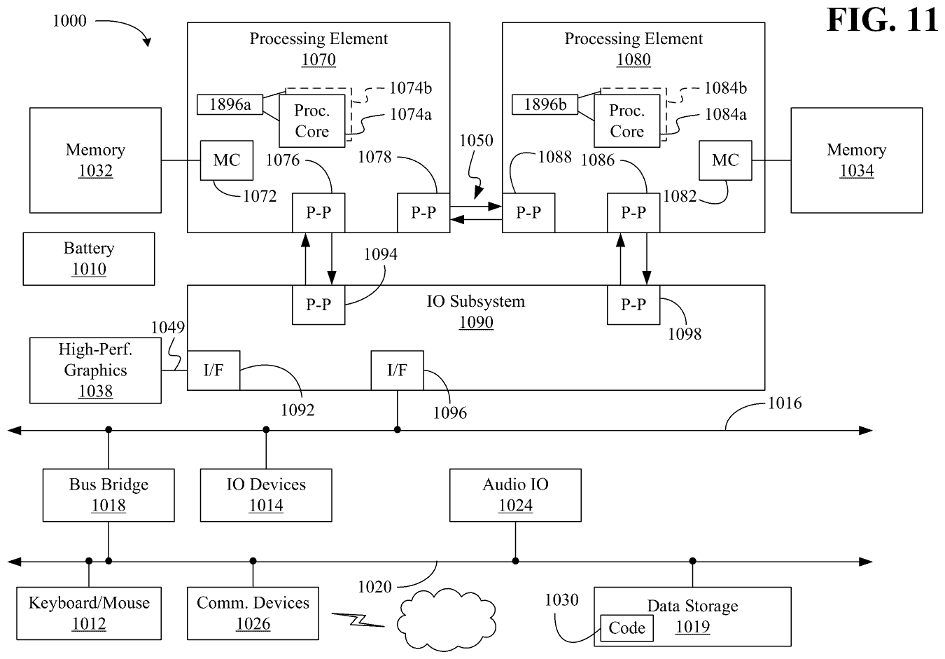

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 5), the method 90 (FIG. 6) and/or the method 100 (FIG. 7), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### ADDITIONAL NOTES AND EXAMPLES

Example 1 includes a performance-enhanced computing system comprising a network controller, a processor coupled to the network controller, and a memory coupled to the processor, the memory including a plurality of executable program instructions, which when executed by the processor, cause the processor to select a subset of linear layers from a plurality of linear layers in a pre-trained artificial intelligence (AI) model, wherein a quantization error of the subset of linear layers exceeds an error threshold, and for each linear layer in the subset of linear layers, solve a singular value decomposition (SVD) approximation, generate a first adapter layer and a second adapter layer based on the SVD decomposition, wherein the first adapter layer and the second adapter layer include weight matrices having a first dimension that is less than a first rank threshold and a second dimension that is greater than a second rank threshold, and determine an inference output based on the linear layer, the first adapter layer and the second adapter layer.

Example 2 includes the computing system of Example 1, wherein the plurality of executable program instructions, when executed, further cause the processor to determine a first compute output of the first adapter layer based on an activation input, determine a second compute output of the second adapter layer based on the first compute output, determine a third compute output of the linear layer based on the activation input, and sum the second compute output with the third compute output to obtain the inference output.

Example 3 includes the computing system of Example 2, wherein the plurality of executable program instructions, when executed, further cause the processor to approximate a distribution of the activation input, and wherein the SVD approximation is solved based on the distribution.

Example 4 includes the computing system of Example 3, wherein the plurality of executable program instructions, when executed, cause the processor to compute a vector, and normalize the vector, wherein the SVD approximation is solved further based on the normalized vector.

Example 5 includes the computing system of any one of Examples 2 to 4, wherein the plurality of executable program instructions, when executed, further cause the processor to quantize the activation input and the first compute output to an eight-bit integer data format, and wherein the subset of linear layers is selected based on one or more signal to quantization noise ratio values.

Example 6 includes at least one computer readable storage medium comprising a plurality of executable program instructions, which when executed by a computing system, cause the computing system to select a subset of linear layers from a plurality of linear layers in a pre-trained artificial intelligence (AI) model, wherein a quantization error of the subset of linear layers exceeds an error threshold, and for each linear layer in the subset of linear layers solve a singular value decomposition (SVD) approximation, generate a first adapter layer and a second adapter layer based on the SVD approximation, wherein the first adapter layer and the second adapter layer include weight matrices having a first dimension that is less than a first rank threshold and a second dimension that is greater than a second rank threshold, and determine an inference output based on the linear layer, the first adapter layer and the second adapter layer.

Example 7 includes the at least one computer readable storage medium of Example 6, wherein the plurality of executable program instructions, when executed, further cause the computing system to determine a first compute output of the first adapter layer based on an activation input, determine a second compute output of the second adapter layer based on the first compute output, determine a third compute output of the linear layer based on the activation input, and sum the second compute output with the third compute output to obtain the inference output.

Example 8 includes the at least one computer readable storage medium of Example 7, wherein the plurality of executable program instructions, when executed, further cause the computing system to quantize the activation input and the first compute output.

Example 9 includes the at least one computer readable storage medium of Example 8, wherein the activation input and the first compute output are quantized to an eight-bit integer data format.

Example 10 includes the at least one computer readable storage medium of Example 7, wherein the plurality of executable program instructions, when executed, further cause the computing system to approximate a distribution of the activation input, and wherein the SVD approximation is solved based on the distribution.

Example 11 includes the at least one computer readable storage medium of Example 10, wherein the plurality of executable program instructions, when executed, cause the computing system to compute a vector, and normalize the vector, wherein the SVD approximation is solved further based on the normalized vector.

Example 12 includes the at least one computer readable storage medium of any one of Examples 6 to 11, wherein the subset of linear layers is selected based on one or more signal to quantization noise ratio values.

Example 13 includes a semiconductor apparatus comprising one or more substrates, and logic coupled to the one or more substrates, wherein the logic is implemented at least partly in one or more of configurable or fixed-functionality hardware, the logic to select a subset of linear layers from a plurality of linear layers in a pre-trained artificial intelligence (AI) model, wherein a quantization error of the subset of linear layers exceeds an error threshold, and for each linear layer in the subset of linear layers solve a singular value decomposition (SVD) approximation, generate a first adapter layer and a second adapter layer based on the SVD approximation, wherein the first adapter layer and the second adapter layer include weight matrices having a first dimension that is less than a first rank threshold and a second dimension that is greater than a second rank threshold, and determine an inference output based on the linear layer, the first adapter layer and the second adapter layer.

Example 14 includes the semiconductor apparatus of Example 13, wherein the logic is further to determine a first compute output of the first adapter layer based on an activation input, determine a second compute output of the second adapter layer based on the first compute output, determine a third compute output of the linear layer based on the activation input, and sum the second compute output with the third compute output to obtain the inference output.

Example 15 includes the semiconductor apparatus of Example 14, wherein the logic is further to quantize the activation input and the first compute output.

Example 16 includes the semiconductor apparatus of Example 15, wherein the activation input and the first compute output are quantized to an eight-bit integer data format.

Example 17 includes the semiconductor apparatus of Example 14, wherein the logic is further to approximate a distribution of the activation input, and wherein the SVD approximation is solved based on the distribution.

Example 18 includes the semiconductor apparatus of Example 17, wherein the logic is further to compute a vector, and normalize the vector, wherein the SVD approximation is solved further based on the normalized vector.

Example 19 includes the semiconductor apparatus of any one of Examples 13 to 18, wherein the subset of linear layers is selected based on one or more signal to quantization noise ratio values.

Example 20 includes the semiconductor apparatus of any one of Examples 13 to 19, wherein the logic coupled to the one or more substrates includes transistor regions that are positioned within the one or more substrates.

Example 21 includes a method of operating a performance-enhanced computing system, the method comprising selecting a subset of linear layers from a plurality of linear layers in a pre-trained artificial intelligence (AI) model, wherein a quantization error of the subset of linear layers exceeds an error threshold, and for each linear layer in the subset of linear layers solving a singular value decomposition (SVD) approximation, generating a first adapter layer and a second adapter layer based on the SVD approximation, wherein the first adapter layer and the second adapter layer include weight matrices having a first dimension that is less than a first rank threshold and a second dimension that is greater than a second rank threshold, and determining an inference output based on the linear layer, the first adapter layer and the second adapter layer.

Example 22 includes an apparatus comprising means for performing the method of Example 21.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a plurality of executable program instructions, which when executed by the processor, cause the processor to:
select a subset of linear layers from a plurality of linear layers in a pre-trained artificial intelligence (AI) model, wherein a quantization error of the subset of linear layers exceeds an error threshold; and
for each linear layer in the subset of linear layers:
solve a singular value decomposition (SVD) approximation,
generate a first adapter layer and a second adapter layer based on the SVD approximation, wherein the first adapter layer and the second adapter layer include weight matrices having a first dimension that is less than a first rank threshold and a second dimension that is greater than a second rank threshold, and
determine an inference output based on the linear layer, the first adapter layer and the second adapter layer.

2. The computing system of claim 1, wherein the plurality of executable program instructions, when executed, further cause the processor to:
determine a first compute output of the first adapter layer based on an activation input,
determine a second compute output of the second adapter layer based on the first compute output,
determine a third compute output of the linear layer based on the activation input, and
sum the second compute output with the third compute output to obtain the inference output.

3. The computing system of claim 2, wherein the plurality of executable program instructions, when executed, further cause the processor to approximate a distribution of the activation input, and wherein the SVD approximation is solved based on the distribution.

4. The computing system of claim 3, wherein the plurality of executable program instructions, when executed, cause the processor to:
compute a vector, and
normalize the vector, wherein the SVD approximation is solved further based on the normalized vector.

5. The computing system of claim 2, wherein the plurality of executable program instructions, when executed, further cause the processor to quantize the activation input and the first compute output to an eight-bit integer data format, and wherein the subset of linear layers is selected based on one or more signal to quantization noise ratio values.

6. At least one computer readable storage medium comprising a plurality of executable program instructions, which when executed by a computing system, cause the computing system to:
select a subset of linear layers from a plurality of linear layers in a pre-trained artificial intelligence (AI) model, wherein a quantization error of the subset of linear layers exceeds an error threshold; and
for each linear layer in the subset of linear layers:
solve a singular value decomposition (SVD) approximation,
generate a first adapter layer and a second adapter layer based on the SVD approximation, wherein the first adapter layer and the second adapter layer include weight matrices having a first dimension that is less than a first rank threshold and a second dimension that is greater than a second rank threshold, and
determine an inference output based on the linear layer, the first adapter layer and the second adapter layer.

7. The at least one computer readable storage medium of claim 6, wherein the plurality of executable program instructions, when executed, further cause the computing system to:
determine a first compute output of the first adapter layer based on an activation input,
determine a second compute output of the second adapter layer based on the first compute output,
determine a third compute output of the linear layer based on the activation input, and
sum the second compute output with the third compute output to obtain the inference output.

8. The at least one computer readable storage medium of claim 7, wherein the plurality of executable program instructions, when executed, further cause the computing system to quantize the activation input and the first compute output.

9. The at least one computer readable storage medium of claim 8, wherein the activation input and the first compute output are quantized to an eight-bit integer data format.

10. The at least one computer readable storage medium of claim 7, wherein the plurality of executable program instructions, when executed, further cause the computing system to approximate a distribution of the activation input, and wherein the SVD approximation is solved based on the distribution.

11. The at least one computer readable storage medium of claim 10, wherein the plurality of executable program instructions, when executed, cause the computing system to:
compute a vector, and
normalize the vector, wherein the SVD approximation is solved further based on the normalized vector.

12. The at least one computer readable storage medium of claim 6, wherein the subset of linear layers is selected based on one or more signal to quantization noise ratio values.

13. A semiconductor apparatus comprising:
one or more substrates; and
logic coupled to the one or more substrates, wherein the logic is implemented at least partly in one or more of configurable or fixed-functionality hardware, the logic to:
select a subset of linear layers from a plurality of linear layers in a pre-trained artificial intelligence (AI) model, wherein a quantization error of the subset of linear layers exceeds an error threshold; and
for each linear layer in the subset of linear layers:
solve a singular value decomposition (SVD) approximation,
generate a first adapter layer and a second adapter layer based on the SVD approximation, wherein the first adapter layer and the second adapter layer include weight matrices having a first dimension that is less than a first rank threshold and a second dimension that is greater than a second rank threshold, and
determine an inference output based on the linear layer, the first adapter layer and the second adapter layer.

14. The semiconductor apparatus of claim 13, wherein the logic is further to:
determine a first compute output of the first adapter layer based on an activation input,
determine a second compute output of the second adapter layer based on the first compute output,
determine a third compute output of the linear layer based on the activation input, and
sum the second compute output with the third compute output to obtain the inference output.

15. The semiconductor apparatus of claim 14, wherein the logic is further to quantize the activation input and the first compute output.

16. The semiconductor apparatus of claim 15, wherein the activation input and the first compute output are quantized to an eight-bit integer data format.

17. The semiconductor apparatus of claim 14, wherein the logic is further to approximate a distribution of the activation input, and wherein the SVD approximation is solved based on the distribution.

18. The semiconductor apparatus of claim 17, wherein the logic is further to:
compute a vector, and
normalize the vector, wherein the SVD approximation is solved further based on the normalized vector.

19. The semiconductor apparatus of claim 13, wherein the subset of linear layers is selected based on one or more signal to quantization noise ratio values.

20. The semiconductor apparatus of claim 13, wherein the logic coupled to the one or more substrates includes transistor regions that are positioned within the one or more substrates.
